(19) United States
(12) Patent Application Publication
(10) Pub. No.: US 2025/0063395 A1
(43) Pub. Date: Feb. 20, 2025

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/806,737

(22) Filed: Aug. 16, 2024

(30) Foreign Application Priority Data
Aug. 18, 2023 (CN) 202311048907.0

(51) Int. Cl. H04W 24/04; H04W 24/08; H04W 76/19

(52) U.S. Cl. CPC H04W 24/04; H04W 24/08; H04W 76/19

(57) ABSTRACT

Receiving a first signaling, the first signaling configuring a first timer; an expiration of the first timer determining that there is a connection problem; starting the first timer, a value of the first timer depending on a first condition; when the first condition is met, a value of the first timer being a first value; when the first condition is not met, a value of the first timer being a second value; herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers. The present application enables a more appropriate determination of whether there is a problem with the connection.

### CROSS REFERENCE TO RELATED APPLICATIONS

This application claims the priority benefit of Chinese Patent Application No. 202311048907.0, filed on Aug. 18, 2023, the full disclosure of which is incorporated herein by reference.

### BACKGROUND

### Technical Field

The present application relates to transmission methods and devices in wireless communication systems, involving a determination of a value of a timer, and in particular to a determination of a value of a timer for determining that there is a problem with a connection, involving mobility management and artificial intelligence.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72th plenary decided to conduct a study of New Radio (NR), or what is called fifth Generation (5G). A work Item (WI) of NR was approved at 3GPP RAN #75th plenary to start standardization work on NR.

In communications, whether Long Term Evolution (LTE) or 5G NR involves features of accurate reception of reliable information, optimized energy efficiency ratio, determination of information efficiency; flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

Concepts, terms, and abbreviations used in the present application can refer to the 3GPP standard, including but not limited to:
https://www.3gpp.org/ftp/Specs/archive/21_series/21.905/21905-h10.zip
https://www.3gpp.org/ftp/Specs/archive/38_series/38.300/38300-h10.zip
https://www.3gpp.org/ftp/Specs/archive/38_series/38.331/38331-h10.zip
https://www.3gpp.org/ftp/Specs/archive/38_series/38.321/38321-h10.zip
https://www.3gpp.org/ftp/Specs/archive/38_series/38.133/38133-h10.zip

### SUMMARY

Researchers have found that in wireless communications, how to better control a value of a timer used to determine connection problems is a problem that needs to be addressed. Researchers further found that if a value of a first timer is configured too small, it can cause a problem to be determined before it actually occurs, leading to entering RRC_IDLE state or initiating RRC connection re-establishment, which can cause communication interruption; if a value of a first timer is configured too high, it will cause connection problems not detected in a timely manner, which will also cause communication interruptions and resource waste; researchers further found that due to the complexity of channel state, it is best for a value of a first timer to have some adaptability; rather than always using a single value, such as always using a network configuration value, which is difficult to adapt to changes in the channel state. Researchers further found that with the advancement of technical means, a more reasonable value for a first timer can be determined to a certain extent by the first node through methods such as artificial intelligence machine learning, rather than using network configuration values, which can more accurately and timely adapt to changes in channel state, and also better adapt to the capabilities of the first node, such as channel detection capabilities. Therefore, by the above method, the value of the first timer can be determined more accurately; and it is possible to determine more accurately whether there is a problem with the connection, which improves the user experience, improves the service quality, avoids communication interruption, and saves network resources.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. Meanwhile, the method proposed in the present application can also be used to solve other communication problems, such as NR evolution and problems in 6G systems, and the present application is applicable to various 3GPP-based communication networks.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first signaling, the first signaling configuring a first timer; an expiration of the first timer determining that there is a connection problem; and starting the first timer, a value of the first timer depending on a first condition; when the first condition
is met, a value of the first timer being a first value; when the first condition is not met, a value of the first timer being a second value;
herein, the meaning of the phrase that an expiration of the first timer determines that there is a connection problem is: an expiration of the first timer triggers entering RRC (Radio Resource Control)_IDLE state, or an expiration of the first timer triggers an RRC connection re-establishment, or RRC reports connection failure to higher layers; the first condition depends on at least one of first location information or first time information.

In one embodiment, a problem to be solved in the present application comprises: how to more accurately determine a value of a timer used to detect connection problems.

In one embodiment, advantages of the above method comprise: being more flexible and more accurate, avoiding the communication interruption, better adapting to the complex and changeable channel environment, saving more resources, and improving the user experience.

Specifically, according to one aspect of the present application, transmit first information; the first information indicates a first capability; herein, the first capability supports using multiple values for the first timer; the first signaling depends on the first capability.

Specifically, according to one aspect of the present application, transmit first information; the first information indicates a second capability; herein, the second capability supports a first-type generator; the first-type generator depends on training; the first-type generator determines whether the first condition is met.

Specifically; according to one aspect of the present application, receive a second signaling, the second signaling comprises a first parameter set, and a generation of the first location information and the first time information depends on the first parameter set; herein, the meaning of the phrase that a generation of the first location information and the first time information depends on the first parameter set comprises: the first parameter set indicates a prediction model that generates at least one of the first location information or the first time information, or the training of the prediction model that generates at least one of the first location information or the first time information depends on the first parameter set.

Specifically, according to one aspect of the present application, the phrase that the first signaling configures a first timer comprises configuring the first value and the second value.

Specifically, according to one aspect of the present application, the phrase that the first signaling configures a first timer comprises configuring the first value and a first increment, and the second value is equal to a sum of the first value and the first increment.

Specifically, according to one aspect of the present application, the phrase that the first signaling configures a first timer comprises configuring the first value and a first value range, and the second value depends on the first value and the first value range.

Specifically, according to one aspect of the present application, a second timer is started, and a value of the second timer depends on a second condition;
herein, the first signaling configures the second timer, and an expiration of the second timer determines that there is a problem with data reception; the meaning of the phrase that an expiration of the second timer determines that there is a connection problem is: an expiration of the second timer triggers dropping at least one packet, or an expiration of the second timer triggers submitting at least one SDU (Service Data Unit) to a higher layer, or an expiration of the second timer determines losing an uplink synchronization; the second condition depends on at least one of second location information or second time information; when the second condition is met, a value of the second timer is a third value; when the second condition is not met, a value of the second timer is a fourth value.

Specifically, according to one aspect of the present application, the behavior of starting the first timer comprises setting a value of the first timer according to whether the first condition is met.

Specifically, according to one aspect of the present application, the first node is an IoT terminal.

Specifically, according to one aspect of the present application, the first node is a UE.

Specifically; according to one aspect of the present application, the first node is an access network device.

Specifically; according to one aspect of the present application, the first node is an aircraft or a vehicle mounted terminal.

Specifically, according to one aspect of the present application, the first node is a mobile phone.

Specifically, according to one aspect of the present application, the first node supports multiple SIM cards.

The present application provides a first node for wireless communications, comprising:
a first receiver, receiving a first signaling, the first signaling configuring a first timer; an expiration of the first timer determining that there is a connection problem; and
a first transceiver, starting the first timer, a value of the first timer depending on a first condition; when the first condition is met, a value of the first timer being a first value; when the first condition is not met, a value of the first timer being a second value;
herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

In one embodiment, the present application has the following advantages over conventional schemes:
the value of the first timer used to determine the first timer with connection problems is not fixed but optional among multiple values, or determined within a certain range by the first node itself, e.g., according to the real-time channel state, service requirements, which can greatly increase flexibility and optimize to a certain extent.
the first timer used to determine that there is a problem with the connection is a special timer rather than generic or other type of timer, and when they expire is often not predictable by the network, so a change in the value of the first timer does not affect the processing on the network side.
the network may control a range of values of the first timer for different functions, such as only being appropriately lengthened, or only being appropriately shortened, or both lengthened and shortened, which facilitates assisting in more accurately controlling the value of the first timer, reducing the stress on the network-side algorithms, and saving resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling and starting a first timer according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of mobility management according to one embodiment of the present application;

FIG. 7 illustrates a schematic diagram of an artificial intelligence processing system according to one embodiment of the present application;

FIG. 8 illustrates a schematic diagram of a generation of second information according to one embodiment of the present application;

FIG. 9 illustrates a schematic diagram of a first encoder according to one embodiment of the present application;

FIG. 10 illustrates a schematic diagram of a first function according to one embodiment of the present application;

FIG. 11 illustrates a schematic diagram of a generation of first location information and first time information depending on a first parameter set according to one embodiment of the present application;

FIG. 12 illustrates a schematic diagram of a first condition depending on at least one of first location information or first time information according to one embodiment of the present application;

FIG. 13 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

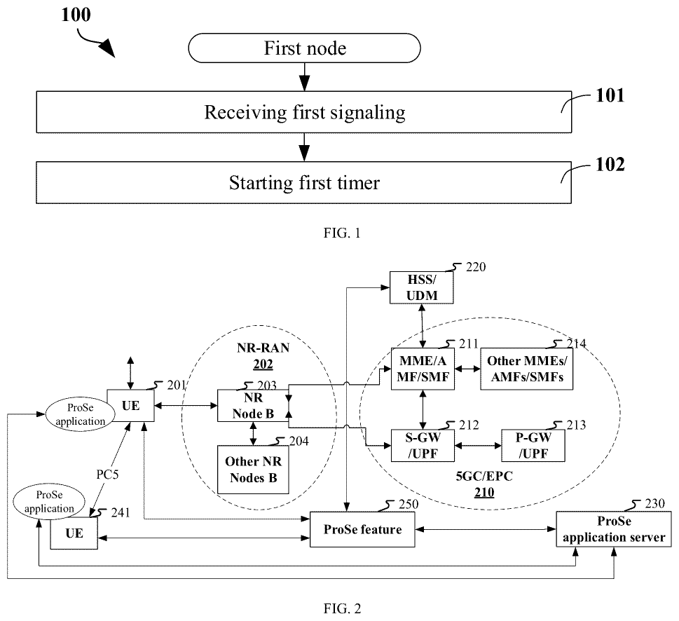

Embodiment 1 illustrates a flowchart of receiving a first signaling and starting a first timer according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101; starts a first timer in step 102.
herein, the first signaling configures a first timer; an expiration of the first timer determines that there is a connection problem; a value of the first timer depends on a first condition; when the first condition is met, a value of the first timer is a first value; when the first condition is not met, a value of the first timer is a second value;
herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

In one embodiment, the first node is a User Equipment (UE).

In one embodiment, the first node is in RRC_CONNECTED state.

In one subembodiment of the embodiment, the first node is in RRC_CONNECTED state upon receiving the first signaling.

In one subembodiment of the embodiment, upon starting the first timer, the first node is in RRC_CONNECTED state or a state other than RRC_CONNECTED state.

In one embodiment, the first node is in non-RRC_CONNECTED state.

In one subembodiment of the embodiment, the first timer is initiated during RRC connection establishment or connection recovery.

In one embodiment, any parameter in the present application can either be configured by the network or generated by the first node according to internal algorithms, such as random ones.

In one embodiment, the present application is for NR.

In one embodiment, the present application is for NR evolved radio communication networks.

In one embodiment, a serving cell refers to a cell where a UE camps; executing a cell search comprises: a UE searches for a suitable cell of a selected Public Land Mobile Network (PLMN) or a Stand-alone Non-Public Network (SNPN), selects the suitable cell to provide available services, and monitors a control channel of the suitable cell, and this procedure is defined as camping on a cell; that is, a camped cell is a serving cell of the UE relative to the UE. Advantages of camping on a cell in RRC_IDLE state or RRC_INACTIVE state: enabling the UE to receive a system message from the PLMN or the SNPN; after registration, if the UE wishes to establish an RRC connection or continue a suspended RRC connection, the UE can achieve this by executing an initial access on a control channel of residing camping cell; the network may page the UE; so that the UE can receive notifications of Earthquake and Tsunami Warning System (ETWS) and Commercial Mobile Alert System (CMAS).

In one embodiment, for a UE in RRC_CONNECTED state that is not configured with carrier aggregation/dual connectivity (CA/DC), only one serving cell comprises a PCell; if a UE is only connected to one cell, then this cell is a main cell of UE. For a UE in RRC_CONNECTED state that is configured with CA/DC, a serving cell is used to indicate a cell set comprising a Special Cell (SpCell) and all sub-cells. The PCell is a cell in a Master Cell Group (MCG), which works at primary frequency, and the UE executes an initial connection establishment procedure or initiates a connection re-establishment on the PCell. For a dual connectivity operation, a Secondary Cell Group (SCG) refers to a PCell of an MCG or a Primary SCG Cell (PSCell) of an SCG; if it is not a dual connectivity operation, an SpCell refers to a PCell.

In one embodiment, a frequency at which a Secondary Cell (SCell) operates is a sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in MR-DC, a control plane connection to the core network is not provided, and a radio access node providing extra resources to the UE is a sub-node. The sub-node can be an en-gNB, a sub-ng-eNB or a sub-gNB.

In one embodiment, in MR-DC, a group of serving cells associated with a sub-node is a Secondary Cell Group (SCG), comprising an SpCell and, optionally, one or multiple SCells.

In one embodiment, the SpCell is a PCell or the SpCell is a PSCell.

In one embodiment, the method proposed in the present application is applicable to both scenarios with SCG configured and scenarios without SCG configured, especially for scenarios without SCG configured.

In one embodiment, an RRC information block refers to an information element in an RRC message.

In one embodiment, SSB can be referred to as SS/PBCH block, or SS block.

In one embodiment, an RRC information block can comprise one or multiple RRC information blocks.

In one embodiment, an RRC information block may not comprise any RRC information block, but only comprise at least one parameter.

In one embodiment, a radio bearer comprises at least a signaling radio bearer and a data radio bearer.

In one embodiment, a radio bearer is services provided by the PDCP layer to higher layers or an interface of services.

In one subembodiment of the above embodiment, the higher layer comprises one of the RRC layer, the NAS layer, and the SDAP layer.

In one embodiment, a signaling radio bearer is services provided by PDCP to higher layers or an interface of services.

In one subembodiment of the above embodiment, the higher layer comprises at least former of the RRC layer and the NAS.

In one embodiment, a data radio bearer is services provided by PDCP to higher layers or an interface of services.

In one subembodiment of the above embodiment, the higher layer comprises at least former of the SDAP layer and the NAS.

In one embodiment, the first signaling is an RRC signaling.

In one embodiment, the first signaling is a signaling of the protocol layer above the RRC layer.

In one embodiment, the first signaling is a higher-layer signaling.

In one embodiment, the first signaling is at least partial fields comprising an RRC message. ta

In one embodiment, the first signaling is only partial fields comprising an RRC message.

In one embodiment, the first signaling is a signaling transmitted on SRB1.

In one embodiment, the first signaling is a signaling transmitted on SRB3.

In one embodiment, the first signaling is an RRCReconfiguration message.

In one embodiment, the first signaling comprises an RRCReconfiguration message.

In one embodiment, the first signaling comprises at least partial fields in an RRCReconfiguration message.

In one embodiment, the first signaling comprises an RRCConnectionReconfiguration message.

In one embodiment, the first signaling comprises an RRCReconfigurationNR message.

In one embodiment, the first signaling comprises an RRCReconfigurationENR message.

In one embodiment, content of the first signaling comprises a configuration for the first timer.

In one embodiment, the first signaling is applicable to both situations where the first condition is met and situations where the first condition is not met.

In one embodiment, the behavior of initiating the first timer occurs after the first node receives the first signaling.

In one embodiment, the first signaling indicates the first condition.

In one embodiment, the first signaling indicates at least partial parameters of the first condition.

In one embodiment, the first condition is fixed, such as through a protocol.

In one embodiment, the first condition depends on the implementation of the first node.

In one embodiment, the first condition is fixed in the SIM card of the first node.

In one embodiment, the first condition is configured by the operator.

In one embodiment, the first condition is configured by a signaling other than the first signaling.

In one embodiment, the first node judges whether the first condition is met.

In one embodiment, the first signaling configuring a first timer comprises configuring a value of the first timer.

In one subembodiment of the embodiment, the value of the first timer is measured by ms.

In one subembodiment of the embodiment, the value of the first timer is a positive integer.

In one subembodiment of the embodiment, the first timer, after being started, expires after a period of time of a value of the first timer without intervention.

In one subembodiment of the embodiment, the value of the first timer is an expiration time of the first timer.

In one embodiment, the first signaling configuring a first timer comprises configuring whether a value of the first timer is variable.

In one embodiment, the first signaling configuring a first timer comprises configuring multiple candidate values of the first timer.

In one subembodiment of the embodiment, when the first condition is met, the first node determines a value from multiple values of the first timer.

In one subembodiment of the embodiment, the first counter value is one of the multiple candidate values scheduled by the first counter.

In one subembodiment of the embodiment, the second counter value is one of the multiple candidate values scheduled by the first counter.

In one subembodiment of the embodiment, when the first condition is not met, the first node uses a determined value of the first timer.

In one embodiment, benefits of the above method include: being more flexible, the terminal can determine a more reasonable value of a first timer according to the specific situations, especially according to whether it is at a location determined by first location information and/or a time determined by the first time information, so as to more reasonably control when the first timer expires, which is conducive to avoiding triggering radio link failure too early or too late; configuring multiple candidate values for the network at the same time enables the network generally controllable for determining radio link failure.

In one embodiment, the first timer is started when a problem is detected in the physical layer.

In one subembodiment of the embodiment, the detected physical-layer problem is a physical-layer problem of SpCell.

In one subembodiment of the embodiment, the SpCell is a PCell.

In one embodiment, the first timer is started upon receiving X first-type indication(s) from a lower layer, X being a positive integer.

In one embodiment, the first timer is for PCell.

In one subembodiment of the embodiment, the first node is not configured with SCG.

In one embodiment, the first timer is stopped upon receiving Y second-type indication(s) from a lower layer, Y being a positive integer.

In one subembodiment of the above embodiment, Y is a maximum value of counter N311.

In one subembodiment of the above embodiment, n311 field comprised in the first signaling configures the Y.

In one subembodiment of the above embodiment, Y is configured in a broadcast manner.

In one subembodiment of the above embodiment, the second-type indication is in-sync.

In one subembodiment of the above embodiment, the second-type indication is recovered.

In one subembodiment of the above embodiment, the first timer is or comprises a T310 timer.

In one embodiment, the first timer is stopped upon performing RRC connection re-establishment.

In one embodiment, the first timer is stopped upon performing a conditional reconfiguration.

In one embodiment, the first timer is T310 timer.

In one embodiment, X is a maximum value of counter N310.

In one embodiment, n310 field comprised in the first signaling indicates the X.

In one embodiment, upon receiving the second-type indication from a lower layer, counter N310 is reset.

In one embodiment, counter N310 is incremented by 1 for every first-type indication received from lower layers.

In one embodiment, candidate values for X comprise 1, 2, 3, 4, 6, 8, 10, and 20.

In one embodiment, candidate values for Y comprise 1, 2, 3, 4, 6, 8, and 10.

In one embodiment, X is configured through broadcast.

In one embodiment, the lower layer comprises a protocol layer below an RRC layer.

In one embodiment, the lower layer is or comprises a physical layer.

In one embodiment, the lower layer is or comprises a MAC layer.

In one embodiment, the lower layer is or comprises an RLC layer.

In one embodiment, the first location information comprises regional identity.

In one embodiment, the first location information comprises coordinates of the region.

In one embodiment, region comprised in the first location information is irregular.

In one embodiment, region comprised in the first location information is irregular.

In one embodiment, the first location information comprises at least one region, and the region determined by the first location information is a region outside of the at least one region.

In one embodiment, the first location information is a location within a serving cell of the first node.

In one embodiment, the first location information is a location within at least one cell.

In one embodiment, the location determined by the first location information is a region.

In one embodiment, a location determined by the first location information is associated with at least one cell.

In one subembodiment of the embodiment, the location determined by the first location information comprises an identity of at least one cell.

In one embodiment, the location determined by the first location information is associated with at least one reference signal resource.

In one subembodiment of the embodiment, the location determined by the first location information comprises an identity of at least one reference signal resource.

In one subembodiment of the embodiment, the reference signal resource is an SSB.

In one subembodiment of the embodiment, the reference signal resource is a CSI-RS (channel state information-reference signal).

In one embodiment, the location determined by the first location information comprises a coordinate.

In one subembodiment of the embodiment, a region within X meters of the coordinate belongs to a location determined by the first location information.

In one embodiment, the location determined by the first location information comprises a region.

In one embodiment, the location determined by the first location information comprises a point of interest.

In one embodiment, the location determined by the first location information comprises a reference measurement result of at least one reference signal resource.

In one embodiment, the location determined by the first location information comprises angle information.

In one subembodiment of the embodiment, the above method is more accurate for directional indications.

In one embodiment, the location determined by the first location information comprises vertical height information.

In one subembodiment of the embodiment, the above methods provide more accurate indications for vertical regions, such as scenarios inside elevators.

In one embodiment, the location determined by the first location information is determined by at least one reference signal resource.

In one embodiment, the location determined by the first location information is determined by at least one index.

In one subembodiment of the embodiment, the at least one index is an index of a reference signal or reference signal resource.

In one subembodiment of the embodiment, the at least one index is an index of a sequence.

In one subembodiment of the embodiment, the at least one index is an index of a configuration.

In one embodiment, the first timer is not stopped in a running period.

In one embodiment, the first timer is not restarted in running period.

In one embodiment, the first time information is based on UTC (Universal Time Coordinated) time.

In one embodiment, a time determined by the first time information is at least one time window.

In one subembodiment of the embodiment, any time window comprised in the at least one time window is finite.

In one embodiment, a time determined by the first time information is a limited time period.

In one embodiment, the first time information depends on a value of the first timer.

In one embodiment, the first time information is measured by ms.

In one embodiment, the first time information is measured by s.

In one embodiment, the first time information comprises a first offset, and a time determined by the first offset after a first moment is a beginning of a time determined by the first time information.

In one subembodiment of the above embodiment, the first offset is measured by ms.

In one subembodiment of the above embodiment, the first offset is measured by s.

In one subembodiment of the embodiment, the first time information indicates the first moment.

In one subembodiment of the embodiment, the first moment is a moment upon receiving the first time information.

In one subembodiment of the embodiment, the first moment is a moment of a closest hourly time unit upon receiving the first time information.

In one subembodiment of the embodiment, the hourly time unit is one of millisecond, second, or frame.

In one embodiment, when the first timer is started and not intervened, the first timer expires at a moment determined by the value of the first timer after its start.

In one embodiment, the first-type indication is or comprises failure.

In one embodiment, the first-type indication is or comprises a problem with the physical layer.

In one embodiment, the first-type indication is or comprises out-of-sync.

In one embodiment, the first timer is started upon initiating RRC connection re-establishment.

In one embodiment, the first timer is stopped when a suitable NR cell is selected or a cell using other radio access technologies is selected.

In one embodiment, an expiration of the first timer triggers entering RRC_IDLE state.

In one embodiment, the first timer is T311 timer.

In one embodiment, the first timer is started upon transmitting an RRC recovery request, and the RRC recovery request is not initiated for small data transmission.

In one embodiment, the first timer is stopped upon receiving RRC recovery, RRC establishment, RRC release, or RRC rejection signaling, or upon cell selection or cell reselection.

In one embodiment, the first timer is started upon transmitting an RRC establishment request.

In one embodiment, the first timer is stopped upon receiving an RRC establishment or RRC rejection, or upon cell reselection or higher layer indicating to drop connection establishment.

In one embodiment, the first timer is started when a measurement report for a measurement identity is triggered and T310 timer of PCell is not running, and the measurement identity is configured to use the first timer; the first timer is configured in MCG.

In one embodiment, the first timer is started when a measurement report for a measurement identity is triggered and T310 timer of PSCell is not running, and the measurement identity is configured to use the first timer; the first timer is configured in SCG.

In one embodiment, when N311 consecutive in-sync indications for SpCell are received from lower layers, or RRCReconfiguration with reconfiguration WithSync for a cell group associated with the first timer is received, MobilityFromNRCommand is received, or RRC connection re-establishment is initiated, or rlf-TimersAndConstant is reconfigured, or MCG failure information procedure is initiated, or conditional reconfiguration for a cell group associated with the first timer is performed, or T310 timer of an SpCell for a cell group associated with the first timer expires, the first timer is stopped; when the first timer is associated with an SCG, the first timer is also stopped when the SCG is released.

In one embodiment, the first timer is configured through CellGroupConfig, and when a cell group targeted by the CellGroupConfig is an MCG, a cell group associated with the first timer is MCG; when a cell group targeted by CellGroupConfig is an SCG, a cell group associated with the first timer is SCG.

In one embodiment, the first timer is T312.

In one subembodiment of the embodiment, the first timer is started when a measurement report for a measurement identity is triggered and T310 timer of PCell is not running, and the measurement identity is configured to use the first timer; the first timer is configured in MCG.

In one subembodiment of the embodiment, the first timer is started when a measurement report for a measurement identity is triggered and T310 timer of PSCell is not running, and the measurement identity is configured to use the first timer; the first timer is configured in an SCG.

In one subembodiment of the embodiment, when N311 consecutive in-sync indications for SpCell are received from lower layers, or RRCReconfiguration with reconfiguration WithSync for a cell group associated with the first timer is received, Mobility FromNRCommand is received, or RRC connection re-establishment is initiated, or rlf-TimersAndConstant is reconfigured, or MCG failure information procedure is initiated, or conditional reconfiguration for a cell group associated with the first timer is performed, or T310 timer for an SpCell associated with a cell group associated with the first timer expires, the first timer is stopped; when the first timer is associated with an SCG, the first timer is also stopped when the SCG is released.

In one subembodiment of the embodiment, the first timer is configured through CellGroupConfig, and when a cell group targeted by CellGroupConfig is an MCG, a cell group associated with the first timer is an MCG; when a cell group targeted by CellGroupConfig is an SCG, a cell group associated with the first timer is an SCG.

In one subembodiment of the embodiment, an expiration of the first timer triggers RRC connection re-establishment.

In one subembodiment of the embodiment, the first node is not configured with SCG.

In one embodiment, the first timer is T310.

In one subembodiment of the embodiment, the first timer is activated upon detecting a physical-layer problem with SpCell.

In one subembodiment of the embodiment, the first timer is stopped upon receiving N311 consecutive in-sync indications from lower layers of SpCell, or upon receiving RRCReconfiguration comprising reconfiguration WithSync for a cell group associated with the first timer, or upon receiving Mobility FromNRCommand, or when rlf-TimersAndConstan is reconfigured, or upon initiating a connection re-establishment procedure, or upon performing conditional reconfiguration, or when SCG is released and the first timer is associated with SCG.

In one subembodiment of the embodiment, the first timer is configured through CellGroupConfig, and when a cell group targeted by CellGroupConfig is an MCG, a cell group associated with the first timer is an MCG; when a cell group targeted by CellGroupConfig is an SCG, a cell group associated with the first timer is an SCG.

In one subembodiment of the embodiment, if an SCG is not configured, the first timer must be associated with an MCG, and if an SCG is configured, an MCG and an SCG can each have an instance of the first timer.

In one subembodiment of the embodiment, an expiration of the first timer triggers RRC connection re-establishment.

In one subembodiment of the embodiment, the first node is not configured with SCG.

In one embodiment, the first timer is T311.

In one subembodiment of the embodiment, the first timer is started upon initiating RRC connection re-establishment.

In one subembodiment of the embodiment, the first timer is stopped upon selecting a suitable NR cell.

In one subembodiment of the embodiment, the first timer is stopped upon selecting a cell with other wireless access technologies.

In one subembodiment of the embodiment, an expiration of the first timer triggers entering RRC_IDLE state.

In one embodiment, the first timer is T319.

In one subembodiment of the embodiment, the first timer is started when an RRC recovery request is transmitted and the recovery procedure is not for small data transmission.

In one subembodiment of the embodiment, the first timer is stopped upon receiving RRC restoration, RRC establishment, RRC release, or RRC rejection.

In one subembodiment of the embodiment, the first timer is stopped during cell reselection.

In one subembodiment of the embodiment, an expiration of the first timer triggers entering RRC_CONNECTED state.

In one subembodiment of the embodiment, an expiration of the first timer triggers RRC to report connection failure to higher layers.

In one embodiment, the first timer is T300.

In one subembodiment of the embodiment, the first timer is started when an RRC establishment request is transmitted.

In one subembodiment of the embodiment, the first timer is stopped upon receiving RRC establishment or RRC rejection.

In one subembodiment of the embodiment, the first timer is stopped during cell reselection.

In one subembodiment of the embodiment, the first timer is stopped upon receiving an indication to drop a connection establishment from a higher layer.

In one subembodiment of the embodiment, an expiration of the first timer triggers RRC to report connection failure to higher layers.

In one embodiment, the first timer is dataInactivity Timer.

In one embodiment, when the MAC receives a MAC SDU (Service Data Unit) of the DTCH (Dedicated Traffic Channel) logical channel, DCCH (Dedicated Control Channel) logical channel, CCCH logical channel (Common Control Channel), or groupcast MTCH (MBS Traffic Channel) logical channel, it is started or restarted.

In one embodiment, when MAC transmits a MAC SDU of DTCH logical channel or DCCH logical channel, it is started or restarted.

In one embodiment, the first timer is dataInactivity Timer.

In one subembodiment of the embodiment, when the MAC receives a MAC SDU of DTCH logical channel, DCCH logical channel, CCCH logical channel, or groupcast MTCH logical channel, it is started or restarted.

In one subembodiment of the embodiment, when MAC transmits a MAC SDU of DTCH logical channel or DCCH logical channel, it is started or restarted.

In one subembodiment of the embodiment, when the first timer expires, the MAC layer indicates an expiration of the first timer to higher layers.

In one subembodiment of the embodiment, when the RRC layer receives an indication of an expiration of the first timer from the MAC layer, it enters RRC_IDLE state.

In one embodiment, starting the first timer comprises: setting a value of the first timer and then starting the first timer.

In one subembodiment of the embodiment, a value of the first timer is set to either the first value or the second value.

In one embodiment, a value of the first timer is always set at startup.

In one embodiment, the meaning of the phrase that a value of the first timer depends on a first condition comprises: a value of the first timer is different in two situations: when the first condition is met or not.

In one embodiment, the meaning of the phrase that a value of the first timer depends on a first condition comprises: when the first condition is met, a value of the first timer is a first value; when the first condition is not met, a value of the first timer is a second value.

In one embodiment, the first value is not equal to the second value.

In one embodiment, both the first value and second value are positive integers.

In one embodiment, the first condition depends on only a former of the first location information and the first time information.

In one embodiment, the first condition depends on only a latter of the first location information and the first time information.

In one embodiment, the first condition depends on the first location information and the first time information.

In one embodiment, the meaning of the phrase that a value of the first timer is a first value is: in the behavior of starting the first timer, a value of the first timer is set to the first value.

In one embodiment, the meaning of the phrase that a value of the second timer is a first value is: in the behavior of starting the first timer, a value of the first timer is set to the second value.

In one embodiment, the first node needs to establish an RRC connection with the network for normal communications.

In one embodiment, the first signaling indicates at least one of the first value or the second value.

In one embodiment, at least one of the first value or the second value is determined by the first node itself.

In one embodiment, the first value and the second value are both determined by the first node itself.

In one embodiment, the first signaling indicates the value ranges of the first value and the second value.

In one embodiment, when the first condition is determined by the first node itself, the first value and the second value are also determined by the first node itself.

In one embodiment, benefits of the first node independently determining the first condition comprise: being beneficial for optimizing the first condition according to self-capabilities of the first node and/or the algorithm developed by the manufacturer.

In one embodiment, benefits of the first node independently determining the first value and a second value comprise: when the first condition is determined by the first node itself, it can better coordinate with whether a first condition is met to determine a value of a first timer.

In one embodiment, when the first condition is indicated by the first signaling, the first value and the second value are also indicated by the first signaling.

In one embodiment, benefits of the network indicating the first condition comprise: facilitating the network to determine the first condition according to a large amount of data such as network deployment and road test results, as well as feedback from other users, and the value of the first timer can be better determined according to this determined first condition.

In one embodiment, benefits of the network indicating the first value and a second value comprise: when the first condition is determined by the network, it can better coordinate with whether a first condition is met to determine a value of a first timer.

In one embodiment, the phrase that the first signaling configures a first timer comprises configuring the first value and the second value.

In one embodiment, the phrase that the first signaling configures a first timer comprises configuring at least a former of the first value and the second value.

In one embodiment, the phrase that the first signaling configures a first timer comprises configuring the first value and a first increment, and the second value is equal to a sum of the first value and the first increment.

In one subembodiment of the embodiment, the signaling does not explicitly indicate the second value.

In one subembodiment of the embodiment, the first signaling indicates multiple increments, the first increment is one of the multiple increments, the first node determines one increment from the multiple increments, and the second value is a sum of the first value and the increment determined from the multiple increments.

In one subembodiment of the embodiment, the first node determines an increment from the multiple increments according to internal algorithms or traversal methods.

In one subembodiment of the embodiment, the first node determines an increment with the lowest dropout rate from the multiple increments through simulation according to randomly generated increments.

In one subembodiment of the embodiment, the method of determining the increment with the lowest dropout rate from multiple increments generated randomly by the first node through simulation can find a more suitable increment in situations where there is not a lot of data volume, such as channel measurement.

In one subembodiment of the embodiment, the first node determines an increment from the multiple increments according to channel conditions.

In one subembodiment of the embodiment, the first node determines an increment from the multiple increments according to channel conditions, and the worse the channel quality, the greater the value of the determined increment.

In one subembodiment of the embodiment, the first node determines an increment from the multiple increments according to at least one of the first time information or the first location information.

In one subembodiment of the embodiment, the first node determining an increment from the multiple increments according to at least one of the first time information or the first location information enables the determined second value more closely match the first location information and/or the first time information, and is simpler to implement.

In one subembodiment of the embodiment, the first node determines an increment from the multiple increments according to artificial intelligence and/or machine learning.

In one subembodiment of the embodiment, the first node determines an increment from the multiple increments according to artificial intelligence and/or machine learning, which can more intelligently and accurately determine the second value.

In one embodiment, the phrase that the first signaling configuring a first timer comprises configuring the first value and a first value range, and the second value depends on at least a latter of the first value and the first range.

In one subembodiment of the above embodiment, the network determines the first value range through long-term statistics.

In one subembodiment of the above embodiment, the first value range comprises negative numbers.

In one subembodiment of the above embodiment, the first value range comprises positive numbers.

In one subembodiment of the above embodiment, the first value range does not comprise infinity.

In one subembodiment of the above embodiment, the network determines the first value range according to artificial intelligence and/or machine learning.

In one subembodiment of the above embodiment, the network determines the first value range according to internal algorithms, simulations, or traversal.

In one subembodiment of the above embodiment, the network determines the first value range according to the first location information and the first time information.

In one subembodiment of the above embodiment, the network determines the first value range based on the first location information and the first time information, the larger the location determined by the first location information or the longer the time determined by the first time information, the larger the first value range, which is conducive to ensuring that radio link failure is less likely to occur within the location determined by the first location information and the time determined by the first time information.

In one subembodiment of the above embodiment, the second value does not exceed the value range.

In one subembodiment of the above embodiment, values comprised in the first value range are real numbers.

In one subembodiment of the above embodiment, the second value does not exceed a sum of values within the value range and the first value.

In one subembodiment of the above embodiment, the first node determines the second value within the first value range.

In one subembodiment of the above embodiment, the first node randomly selects a value within the first value range as the second value.

In one subembodiment of the above embodiment, the first node selects a value within the first value range as the second value through artificial intelligence and/or machine learning.

In one subembodiment of the above embodiment, advantages of the first node selecting a value within the first value range as the second value through artificial intelligence and/or machine learning comprises: it can consider richer input parameters, even a large number of inputs, in order to more accurately and intelligently determine the second value and better determine the expiration time of the first timer.

In one embodiment, the behavior of starting the first timer comprises setting a value of the first timer according to whether the first condition is met.

In one subembodiment of the embodiment, the meaning of setting a value of the first timer according to whether the first condition is met is: when the first condition is met, a value of the first timer is a first value; when the first condition is not met, a value of the first timer is a second value.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), non-terrestrial base station communication, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the second node in the present application is a gNB 203.

In one embodiment, a wireless link from the UE 201 to NR node B is uplink.

In one embodiment, a wireless link from NR node B to UE 201 is downlink.

In one embodiment, the UE 201 comprises a mobile phone.

In one embodiment, the UE 201 is a vehicle comprising a car.

In one embodiment, the gNB 203 is a MarcoCellular base station.

In one embodiment, the gNB 203 is a Micro Cell base station.

In one embodiment, the gNB 203 is a Pico Cell base station.

In one embodiment, the gNB 203 is a flight platform.

### Embodiment 3

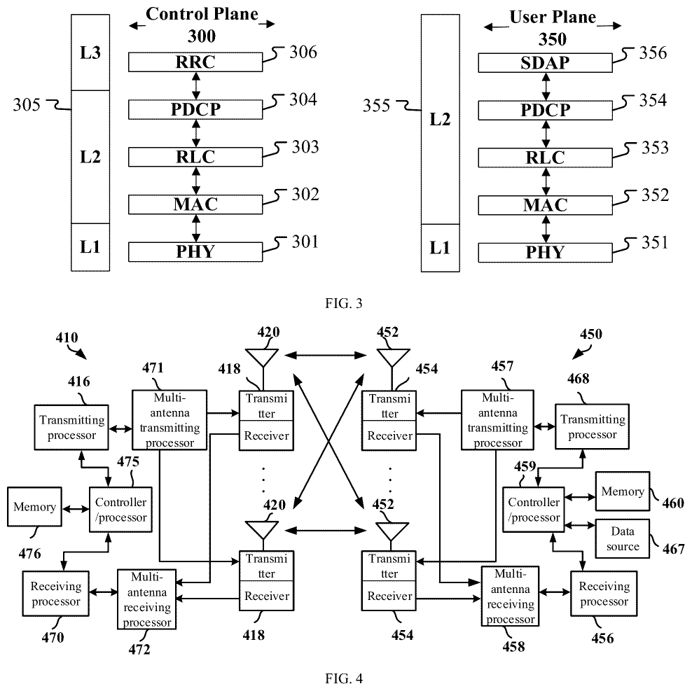

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE or gNB) and a second node (gNB or UE) or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, which is respectively used to transmit different types of control signalings. SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling. Most of the signalings are transmitted through SRB1. If SRB1 is interrupted or unavailable, the UE must perform RRC re-establishment. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first information in the present application is generated by the RRC 306.

In one embodiment, the second signaling in the present application is generated by the RRC 306.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling configures a first timer; an expiration of the first timer determines that there is a connection problem; starts the first timer, a value of the first timer depends on a first condition; when the first condition is met, a value of the first timer is a first value; when the first condition is not met, a value of the first timer is a second value; herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

In one embodiment, the first communication device 450 comprises at least one processor and at least one memory, a memory that stores a computer readable instruction program. The computer readable instruction program generates an action when executed by at least one processor. The action includes: receiving a first signaling, the first signaling configuring a first timer; an expiration of the first timer determining that there is a connection problem; starting the first timer, a value of the first timer depending on a first condition; when the first condition is met, a value of the first timer being a first value; when the first condition is not met, a value of the first timer being a second value; herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the first communication device 450 is a mobile.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the second signaling in the present application.

In one embodiment, the transmitter 454 (comprising antenna 452), the transmitting processor 468 and the controller/processor 459 are used to transmit the first information in the present application.

### Embodiment 5

Embodiment 5 illustrates a flowchart of radio signal transmission according to one embodiment in the present application, as shown in FIG. 5. In FIG. 5, U01 corresponds to a first node in the present application. It is particularly underlined that the order illustrated in the embodiment does not put constraints over sequences of signal transmissions and implementations; steps within F51 and F52 are optional.

The first node U01 transmits first information in step S5101; receives a second signaling in step S5102; receives a first signaling in step S5103; starts a first timer in step S5104; starts a second timer in step S5105.

The second node U02 receives first information in step S5201; transmits a second signaling in step S5202; transmits a first signaling in step S5202.

In embodiment 5, the first signaling configures a first timer; an expiration of the first timer determines that there is a connection problem; a value of the first timer depends on a first condition; when the first condition is met, a value of the first timer is a first value; when the first condition is not met, a value of the first timer is a second value; herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

In one embodiment, the second node U02 is a base station.

In one embodiment, the second node U02 is a network device.

In one embodiment, the second node U02 is a source cell of the first node U01.

In one embodiment, the second node U02 is a source SpCell of the first node U01.

In one embodiment, the second node U02 is an MCG of the first node U01.

In one embodiment, the first signaling configures a candidate value of the first timer, and the candidate value of the first timer comprises the first value and the second value; the first signaling indicates the first location information; the first condition is that the first node U01 is located within a region determined by the first location information.

In one subembodiment of the embodiment, the first condition is not met, that is, the first node U01 is not within a region determined by the first location information; RRC layer of the first node U01 receives N310 out-of-sync indications from the physical layer, which triggers the first node U01 to start the first timer, the first timer is T310 timer, and an expiration of the first timer triggers RRC connection re-establishment: starting the first timer comprises setting a value of the first timer to the first value.

In one subembodiment of the embodiment, the first condition is met, that is, the first node U01 is within a region determined by the first location information; RRC layer of the first node U01 receives N310 out-of-sync indications from the physical layer, which triggers the first node U01 to start the first timer, the first timer is T310 timer, and an expiration of the first timer triggers RRC connection re-establishment; starting the first timer comprises setting a value of the first timer to the second value.

In one subembodiment of the embodiment, the physical layer of the first node U01 evaluates quality of radio link, and whenever the quality of the radio link falls below a first threshold, the physical layer of the first node U01 transmits an out-of-sync indication to higher layers.

In one subembodiment of the embodiment, the higher layer is RRC layer.

In one subembodiment of the embodiment, the first signaling indicates the first threshold.

In one subembodiment of the embodiment, the first threshold may be protocol fixed.

In one subembodiment of the embodiment, the N310 may be protocol fixed.

In one subembodiment of the embodiment, the second node U02 determines the first location information through long-term statistics, computer simulation, or machine learning methods.

In one subembodiment of the embodiment, parameters or methods required but not specified in the embodiment are all existing technologies.

In one embodiment, an expiration of the first timer triggers entering RRC_IDLE state, and the first condition depends on first location information.

In one embodiment, an expiration of the first timer triggers entering RRC_IDLE state, and the first condition depends on first location information and the first time information.

In one embodiment, an expiration of the first timer triggers entering RRC_IDLE state, and the first condition depends on the first time information.

In one embodiment, an expiration of the first timer triggers RRC connection re-establishment, and the first condition depends on first location information.

In one embodiment, an expiration of the first timer triggers an RRC connection re-establishment, and the first condition depends on first location information and the first time information.

In one embodiment, an expiration of the first timer triggers RRC connection re-establishment, and the first condition depends on the first time information.

In one embodiment, the meaning of an expiration of the first timer determining a connection problem is that RRC reports connection failure to a higher layer, and the first condition depends on first location information.

In one embodiment, the meaning of an expiration of the first timer determining a connection problem is that RRC reports connection failure to a higher layer, and the first condition depends on first location information and the first time information.

In one embodiment, the meaning of an expiration of the first timer determining a connection problem is that RRC reports connection failure to a higher layer, and the first condition depends on the first time information.

In one embodiment, the first timer is a timer of RRC layer.

In one embodiment, the first timer is a timer of MAC layer.

In one embodiment, the first timer is a timer of NAS layer.

In one embodiment, whether an expiration of the first timer triggers entering RRC_IDLE state, RRC connection re-establishment, or reporting connection failure to higher layers by RRC depends on starting conditions or starting causes of the first timer.

In one embodiment, whether an expiration of the first timer triggers entering RRC_IDLE state, RRC connection re-establishment, or reporting connection failure to higher layers by RRC depends on the functions or specific implementations of the first timer.

In one embodiment, an expiration of the first timer triggers any of entering RRC_IDLE state, or RRC connection re-establishment, or reporting connection failure to higher layers by RRC.

In one subembodiment of the embodiment, the implementation complexity of triggering an expiration of the first timer to enter RRC_IDLE state is low.

In one subembodiment of the embodiment, an expiration of the first timer triggering RRC connection re-establishment is beneficial for reducing interruption time.

In one subembodiment of the embodiment, an expiration of the first timer triggering RRC connection re-establishment is beneficial for higher layers to adopt NAS-based solution strategies, such as selecting other PLMNs.

In one embodiment, how to choose a Public Land Mobile Network (PLMN) for a Non-Access-stratum (NAS) is an existing technology in this field.

In one embodiment, step S5101 is taken before step S5102.

In one embodiment, step S5102 is taken before step S5103.

In one embodiment, step S5103 is taken before step S5104.

In one embodiment, step S5104 is taken before step S5105.

In one embodiment, steps S5104 and S5105 do not require a sequential relation.

In one embodiment, step S5105 is taken after step S5101.

In one embodiment, step S5201 is taken before step S5202.

In one embodiment, step S5202 is taken before step S5103.

In one embodiment, the first information indicates a first capability.

In one subembodiment of the embodiment, the first capability supports using multiple values for the first timer.

In one subembodiment of the embodiment, the first signaling depends on the first capability.

In one embodiment, the first information comprises an RRC message.

In one embodiment, the first information indicates radio access capability of the first node U01.

In one embodiment, the first information comprises UECapability Information.

In one embodiment, the first information indicates the first capability and a capability other than the first capability.

In one embodiment, the first information indicates a computing capability of the first node U01.

In one embodiment, the first information comprises an identity or index of the first capability.

In one embodiment, the first information comprises a first reference capability, and the first reference capability is used to determine the first capability.

In one embodiment, the first information indicates whether the first capability is supported.

In one embodiment, the first information indicates at least one parameter of the first capability.

In one embodiment, the first capability is a timer-related capability.

In one embodiment, the meaning of the first capability supporting the use of multiple values for the first timer comprises: the first capability supports configuring multiple values for the first timer.

In one subembodiment of the above embodiment, the multiple values comprise the first value and the second value.

In one embodiment, the first value and the second value are determined by the first node U01 itself, or configured by the second node U02, or fixed by the protocol.

In one subembodiment of the embodiment, the first value and the second value are protocol fixed with the advantage of being relatively simple; advantages of the first value and the second value being configured by the second node U02 is that the network can determine the first value and the second value using information from multiple cells or information from multiple users collected by the network; the first value and the second value determined by the first node U01 have the advantages of being more timely and responding quickly to channel changes.

In one embodiment, the meaning of the first capability supporting the use of multiple values for the first timer comprises: the first capability supports that the first timer is configured with at least the first value and the second value.

In one embodiment, the meaning of the first capability supporting the use of multiple values for the first timer comprises: the first capability supports that at least two candidate values are configured for the first timer, and the first node U01 determines a value of the first timer from the at least two candidate values.

In one subembodiment of the above embodiment, the at least two values comprise the first value and the second value.

In one embodiment, the meaning of the phrase that the first signaling depends on the first capability comprises: only after the second node U02 receives the first information, the second node U02 will transmit the first signaling.

In one embodiment, the meaning of the phrase that the first signaling depends on the first capability comprises: if the first node U01 does not indicate supporting the first capability, the second node U02 will not transmit the first signaling.

In one embodiment, the meaning of the phrase that the first signaling depends on the first capability comprises: if the first node U01 indicates not supporting the first capability, the second node U02 will not transmit the first signaling.

In one embodiment, the first information indicates a second capability;

In one subembodiment of the embodiment, the second capability supports a first-type generator.

In one subembodiment of the embodiment, the first-type generator depends on training.

In one subembodiment of the embodiment, the first-type generator determines whether the first condition is met.

In one embodiment, the second capability is related to artificial intelligence.

In one embodiment, the second capability is related to machine learning.

In one embodiment, the second capability is related to neural networks.

In one embodiment, the second capability is related to prediction.

In one embodiment, the first-type generator comprises the second processor in embodiment 7.

In one embodiment, the first-type generator comprises the third processor in embodiment 7.

In one embodiment, the first-type generator comprises the first encoder in embodiment 8.

In one embodiment, the first-type generator comprises a first function in embodiment 9.

In one embodiment, the first-type generator generates the first condition.

In one embodiment, the first-type generator generates a candidate value for the first timer.

In one embodiment, the first-type generator generates the first value.

In one embodiment, the first-type generator generates the second value.

In one embodiment, the first-type generator is related to artificial intelligence.

In one embodiment, the first-type generator is related to machine learning.

In one embodiment, the first-type generator is related to neural networks.

In one embodiment, the first-type generator is used for prediction.

In one embodiment, the first-type generator generates the second value according to at least one of the first location information or the first time information.

In one embodiment, the first-type generator generates a result of whether the first condition is met.

In one embodiment, the first-type generator generates a result of whether the first condition is met according to at least one of the first location information or the first time information.

In one embodiment, the first-type generator generates the first time information according to the first location information.

In one embodiment, the first-type generator generates the first location information according to the first time information.

In one embodiment, training of the first-type generator is offline.

In one embodiment, training of the first-type generator is online.

In one embodiment, training of the first-type generator is based on past data.

In one embodiment, training of the first-type generator is based on an input of the second node U02.

In one embodiment, the first node U01 indicates whether the first-type generator has been trained.

In one subembodiment of the embodiment, the first node U01 indicates to the second node U02 whether the first-type generator has been trained.

In one subembodiment of the embodiment, the first node U01 indicates to the second node U02 whether the first generator has been trained.

In one subembodiment of the embodiment, the first node U01 requests training for the first generator.

In one embodiment, the first node U01 indicates whether the first-type generator is available.

In one subembodiment of the embodiment, the first node U01 indicates to the second node U02 whether the first-type generator has been trained.

In one subembodiment of the embodiment, the first node U01 indicates to the second node U02 whether the first generator has been trained.

In one subembodiment of the embodiment, the first node U01 requests training for the first generator.

In one embodiment, the first generator belongs to the first-type generator.

In one embodiment, the first generator determines whether the first condition is met.

In one subembodiment of the embodiment, a comparison between a result of the first generator and a threshold is used to determine whether the first condition is met.

In one subsidiary embodiment of the above subembodiment, the threshold is determined by the first node U01 or is determined by the second node U02 and is indicated to the first node U01.

In one subsidiary embodiment of the above subembodiment, if a result of the first generator is greater than the threshold, the first condition is not met.

In one subsidiary embodiment of the above subembodiment, if a result of the first generator is not greater than the threshold, the first condition is met.

In one subembodiment of the embodiment, a confidence level of an output of the first generator is used to determine whether the first condition is met.

In one subembodiment of the embodiment, information entropy or entropy of information output by the first generator is used to determine whether the first condition is met.

In one subembodiment of the embodiment, a residual of an output of the first generator is used to determine whether the first condition is met.

In one subembodiment of the embodiment, a convergence of an output of the first generator is used to determine whether the first condition is met.

In one embodiment, the first generator estimates channel state of the first node U01.

In one embodiment, the first generator predicts channel state of the first node U01.

In one subembodiment of the embodiment, the first generator predicts that channel state is improved after T milliseconds, and when T is less than a third threshold, the second value depends on T, for example, the second value is set to T.

In one subsidiary embodiment of the above subembodiment, when T is greater than the third threshold, the first condition is not met.

In one subsidiary embodiment of the above subembodiment, when T is greater than the third threshold, the second value is less than the first threshold.

In one subsidiary embodiment of the above subembodiment, when T is less than the third threshold and greater than the first value, the second value is greater than the first value.

In one subsidiary embodiment of the above subembodiment, the first node U01 determines the third threshold through simulation, big data, or past data.

In one subsidiary embodiment of the above subembodiment, the second node U02 determines the third threshold through simulation, big data, past data, or road testing.

In one embodiment, at least one of the first location information or the first time information is used as an input of the first generator.

In one embodiment, at least one of the first location information or the first time information is used as input to the first generator to determine the second value.

In one embodiment, the second signaling comprises a first parameter set, and the generation of the first location information and the first time information depends on the first parameter set.

In one subembodiment of the embodiment, the meaning of the phrase that a generation of the first location information and the first time information depends on the first parameter set comprises: the first parameter set indicates a prediction model that generates at least one of the first location information or the first time information.

In one subembodiment of the embodiment, the meaning of the phrase that a generation of the first location information and the first time information depends on the first parameter set comprises: the first parameter set indicates the complexity of a prediction model that generates at least one of the first location information or the first time information.

In one subembodiment of the embodiment, the meaning of the phrase that a generation of the first location information and the first time information depends on the first parameter set comprises: the first parameter set indicates a dimensionality of a prediction model that generates at least one of the first location information or the first time information.

In one subembodiment of the embodiment, the meaning of the phrase that a generation of the first location information and the first time information depends on the first parameter set comprises: the first parameter set indicates a number of layer(s) of a prediction model that generates at least one of the first location information or the first time information.

In one subembodiment of the embodiment, the meaning of the phrase that a generation of the first location information and the first time information depends on the first parameter set comprises: the first parameter set indicates a convergence requirement of a prediction model that generates at least one of the first location information or the first time information.

In one subembodiment of the embodiment, the meaning of the phrase that a generation of the first location information and the first time information depends on the first parameter set comprises: the first parameter set indicates an error requirement or accuracy requirement of a prediction model that generates at least one of the first location information or the first time information.

In one subembodiment of the embodiment, the meaning of the phrase that a generation of the first location information and the first time information depends on the first parameter set comprises: training of a prediction model that generates at least one of the first location information or the first time information depends on the first parameter set.

In one subembodiment of the embodiment, the meaning of the phrase that training of a prediction model that generates at least one of the first location information or the first time information depends on the first parameter set comprises: the first parameter controls the training of a prediction model that generates at least one of the first location information or the first time information.

In one subembodiment of the embodiment, the meaning of the phrase that training of a prediction model that generates at least one of the first location information or the first time information depends on the first parameter set comprises: the first parameter serves as an input for the training of a prediction model that generates at least one of the first location information or the first time information.

In one subembodiment of the embodiment, the meaning of the phrase that training of a prediction model that generates at least one of the first location information or the first time information depends on the first parameter set comprises: the first parameter assists in the training of a prediction model that generates at least one of the first location information or the first time information.

In one subembodiment of the embodiment, the meaning of the phrase that training of a prediction model that generates at least one of the first location information or the first time information depends on the first parameter set comprises: the first parameter validates the training of a prediction model that generates at least one of the first location information or the first time information.

In one embodiment, a value of the second timer depends on a second condition.

In one subembodiment of the above embodiment, the meaning of the phrase that a value of the second timer depends on a second condition is: when the second condition is met, a value of the second timer is a third value; when the second condition is not met, a value of the second timer is a fourth value.

In one embodiment, the first signaling configures the second timer.

In one subembodiment of the above embodiment, the meaning of the phrase that the first signaling configures the second timer is: the first signaling configures a value of the second timer.

In one subembodiment of the above embodiment, the meaning of the phrase that the first signaling configures the second timer is: the first signaling configures the third value and the fourth value.

In one subembodiment of the above embodiment, the meaning of the phrase that the first signaling configures the second timer is: the first signaling configures a candidate value for the second timer, and the candidate value for the second timer comprises the third value and the fourth value.

In one subembodiment of the above embodiment, the third value is not equal to the fourth value.

In one subembodiment of the above embodiment, the first node U01 independently determines the third value and the fourth value.

In one subembodiment of the above embodiment, the third value and the fourth value are protocol fixed.

In one subembodiment of the embodiment, the third value and the fourth value are protocol fixed with the advantage of being relatively simple; advantages of the third value and the fourth value being configured by the second node U02 is that the network can determine the third value and the fourth value using information from multiple cells or information from multiple users collected by the network; the third value and the fourth value determined by the first node U01 have the advantage of being more timely and responding quickly to channel changes.

In one embodiment, an expiration of the second timer determines that there is a problem with data reception.

In one embodiment, the meaning of the phrase that an expiration of the second timer determines that there is a connection problem is: an expiration of the second timer triggers dropping at least one packet, or an expiration of the second timer triggers submitting at least one Service Data Unit (SDU) to a higher layer, or an expiration of the second timer triggers losing an uplink synchronization.

In one subembodiment of the embodiment, whether an expiration of the second timer triggers dropping at least one packet, triggers submitting at least one SDU to a higher layer or determines that losing an uplink synchronization depends on a starting condition of the second timer.

In one subembodiment of the embodiment, an expiration of the second timer triggers dropping at least one packet, triggers submitting at least one SDU to a higher layer or determines that losing an uplink synchronization depends on of which protocol layer the second timer is.

In one subembodiment of the embodiment, an expiration of the second timer triggers dropping at least one packet, triggers submitting at least one SDU to a higher layer or determines losing an uplink synchronization depends on function of the second timer.

In one subembodiment of the above embodiment, when the second timer is a timer of a PDCP layer, an expiration of the second timer triggers submitting at least one SDU to a higher layer.

In one subembodiment of the above embodiment, when the second timer is a timer of RLC layer, an expiration of the second timer triggers dropping at least one packet.

In one subembodiment of the above embodiment, when the second timer is a timer of RRC layer, an expiration of the second timer determines losing an uplink synchronization.

In one subembodiment of the above embodiment, when the second timer is a t-Reordering timer, an expiration of the second timer triggers submitting at least one SDU to a higher layer.

In one subembodiment of the above embodiment, when the second timer is a t-Reassembly timer, an expiration of the second timer triggers dropping at least one packet.

In one subembodiment of the above embodiment, when the second timer is a T430 timer, an expiration of the second timer determines losing an uplink synchronization.

In one subembodiment of the above embodiment, when a starting condition of the second timer comprises receiving a valid PDCP PDU (packet data unit) from a lower layer, an expiration of the second timer triggers submitting at least one SDU to the higher layer.

In one subembodiment of the above embodiment, when a starting condition of the second timer comprises that a valid RLC PDU is placed in the receive cache, an expiration of the second timer triggers dropping at least one packet.

In one subembodiment of the above embodiment, when the second timer is started in a subframe specified by the network, an expiration of the second timer determines losing an uplink synchronization.

In one subembodiment of the above embodiment, when the second timer is used to detect losing a PDCP data PDU, an expiration of the second timer triggers submitting at least one SDU to a higher layer.

In one subembodiment of the above embodiment, when the second timer is used to detect a lower layer, such as the MAC layer, where dropping an RLC PDU is that, an expiration of the second timer triggers dropping at least one packet.

In one subembodiment of the above embodiment, when the second timer is used to determine whether an uplink synchronization is lost, an expiration of the second timer determines losing an uplink synchronization.

In one embodiment, the second condition depends on at least one of the second location information or second time information.

In one subembodiment of the above embodiment, the second location information is the first location information.

In one subembodiment of the above embodiment, the second time information is the first time information.

In one subembodiment of the above embodiment, the second condition is met when it is in a location determined by the second location information, that is, in a determined region.

In one subembodiment of the above embodiment, the second condition is met when within a time period determined by the second time information.

In one subembodiment of the above embodiment, the second condition is met when it is in a location determined by the second location information and within a time determined by the second time.

In one subembodiment of the above embodiment, the second location information and the second time information serve as inputs to a generator that determines whether the second condition is met.

In one embodiment, when the second condition is met, a value of the second timer is a third value; when the second condition is not met, a value of the second timer is a fourth value.

In one embodiment, the second location information and/or the second time information are determined by the network.

In one subembodiment of the above embodiment, advantages of being determined by the network is that the network can generate the second location information, and/or the second time information, from the multiple used statistics of multiple cells.

In one embodiment, the second location information, and/or the second time information are determined by the first node U01.

In one subembodiment of the above embodiment, benefits when determined by the first node U01 is to better utilize the first node U01's capabilities, characteristics, such as user habits, movement habits, and implicit data of users that will not be submitted to the network to generate the second location information, and/or the second time information.

In one embodiment, compared with a value of the first timer being the first value, when a value of the first timer is the second value, a stopping condition of the first timer is different.

In one embodiment, compared with a value of the second timer being a third value, when a value of the second timer is the fourth value, a stopping condition of the second timer is different.

In one embodiment, the first signaling and the second signaling belong to a same RRC message.

In one embodiment, the first signaling and the second signaling belong to different RRC messages.

In one embodiment, the second signaling depends on the first capability;

In one embodiment, the second signaling is earlier than the first signaling.

### Embodiment 6

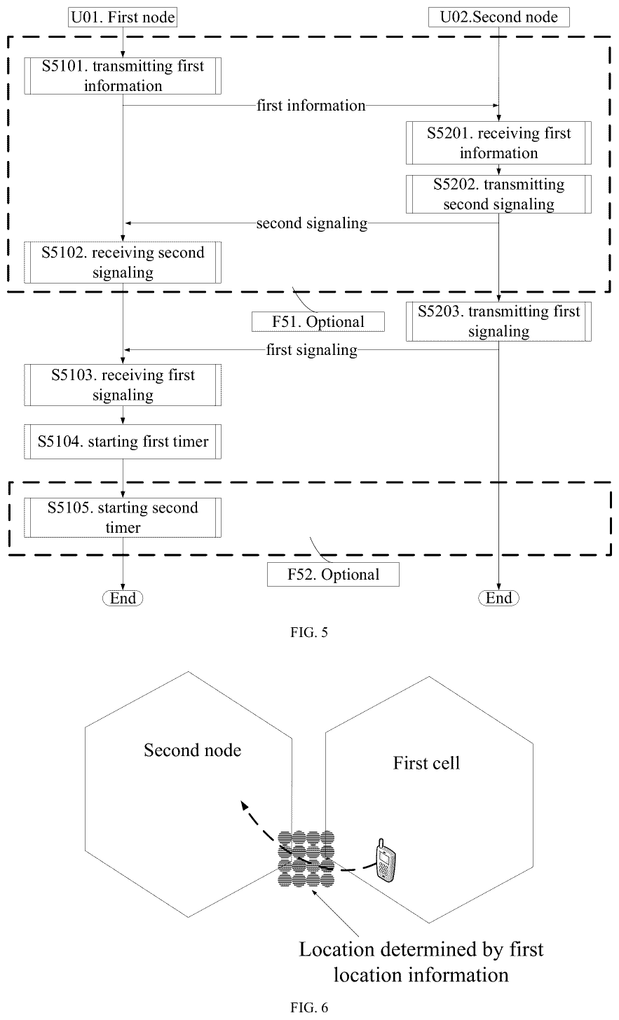

Embodiment 6 illustrates a schematic diagram of mobility management according to one embodiment of the present application, as shown in FIG. 6. The mobile phone in FIG. 6 corresponds to the first node of the present application, the dashed line with an arrow indicates the moving path of the first node, and the black shaded region indicates a location determined by first location information.

In one embodiment, the first condition is: the first node is in a location determined by the first location information and/or within a time determined by the first time information.

In one embodiment, the first location information determines multiple locations, or the first location information determines a region.

In one embodiment, the present application does not limit a shape of a location determined by the first location information.

In one embodiment, a location determined by the first location information comprises multiple sub-regions.

In one subembodiment of the above embodiment, the multiple sub-regions are adjacent.

In one subembodiment of the above embodiment, the multiple sub-regions may be disjointed.

In one subembodiment of the above embodiment, the shape and/or size of the multiple sub-regions are consistent.

In one subembodiment of the above embodiment, the shape and/or size of the multiple sub-regions are not required to be consistent.

In one embodiment, the present application does not restrict the shape of the moving trajectory.

In one embodiment, the first location information indicates a location through at least one index.

In one subembodiment of the embodiment, the index is an index of a region, or an index of a reference signal or a reference signal resource.

In one embodiment, the first location information indicates a location through at least one coordinate.

In one embodiment, the first location information indicates a region through multiple coordinates.

In one embodiment, in FIG. 6, the first cell is a transmitter of the first signaling.

In one embodiment, in FIG. 6, the first node moves from the first cell, and the first node estimates the moving trajectory.

In one subembodiment of the embodiment, the first signaling indicates the first location information.

In one subembodiment of the above embodiment, the first node generates the first time information.

In one subembodiment of the embodiment, the first signaling indicates the first location information and the first time information.

In one embodiment, in FIG. 6, the first node moves from the first cell, and the network estimates the moving trajectory:

In one subembodiment of the embodiment, the first signaling indicates the first location information.

In one subembodiment of the embodiment, the first signaling indicates the first time information.

In one subembodiment of the embodiment, the first signaling indicates the first location information and the first time information.

In one embodiment, in FIG. 6, the first node moves from the first cell, and both the network and the first node estimate the moving trajectory.

In one subembodiment of the embodiment, the first signaling indicates the first location information.

In one subembodiment of the embodiment, the first signaling indicates the first time information.

In one subembodiment of the embodiment, the first signaling indicates the first location information and the first time information.

In one subembodiment of the above embodiment, the first node generates the first location information.

In one subembodiment of the above embodiment, the first node generates the first time information.

In one subembodiment of the embodiment, the first node generates the first location information and the first time information.

In one embodiment, the first location information comprises location information at different times.

In one embodiment, the first location information depends on a time determined by the first time information.

In one embodiment, the first location information depends on the first time information.

In one embodiment, the first location information comprises a time-varying location.

In one subembodiment of the embodiment, the time-varying location depends on a time determined by the first time information.

In one embodiment, the first location information comprises multiple location sub-information.

In one subembodiment of the embodiment, any of the multiple location sub-information indicates a region.

In one subembodiment of the embodiment, in the multiple location sub-information, which location sub-information is selected depends on a time determined by the first time information.

In one subembodiment of the embodiment, advantages of the embodiment comprise: having better support for time-varying environments, i.e. the location sub-information selected from first location information can be different at different times and therefore more accurate.

In one embodiment, the first location information depends on a first index list.

In one subembodiment of the embodiment, each index in the first index list is used to identify a location.

In one subembodiment of the embodiment, the first location information comprises multiple location sub-information, each of which is associated with an index in the first index list.

In one subembodiment of the embodiment, the first node is within a region determined by a first index, and the first index is any index in the first index list; and the first node selects location sub-information in the first location information associated with the first index.

In one subembodiment of the embodiment, the first condition is: the first node is in a location determined by the first location information and/or within a time determined by the first time information.

In one subembodiment of the embodiment, advantages of the embodiment comprise: as the first node moves, corresponding location sub-information in the first location information is selected, which is conducive to more accurate determination of location information affecting a first condition, for example, the entry direction of the first node can be better considered, and different entry directions can be used to determine the stay time in the region determined by the first location information.

In one embodiment, time-related parameters indicated by the first signaling are input into an encoder maintained by the first node to generate the first location information.

In one embodiment, the first node does not trigger radio link failure within a location determined by the first location information in FIG. 6.

In one embodiment, in FIG. 6, the first node leaves a location determined by the first location information and enters a second cell.

In one embodiment, once the first node leaves a location determined by the first location information, the first RRC information block is applied.

In one embodiment, the first RRC information block configures an MCG of the first node.

In one embodiment, the first RRC information block configures a PCell of an MCG of the first node as the second cell.

In one embodiment, before applying the first RRC information block, a PCell of an MCG of the first node is the first cell.

In one embodiment, the meaning of the phrase of at a time determined by the first time information comprises: a current time is a time determined by the first time information.

In one embodiment, the meaning of the phrase of at a time determined by the first time information comprises: within a time determined by the first information.

### Embodiment 7

Embodiment 7 illustrates a schematic diagram of an artificial intelligence processing system according to one aspect of the present application, as shown in FIG. 7. FIG. 7 comprises a first processor, a second processor, a third processor, and a fourth processor.

In Embodiment 7, the first processor transmits a first data set to the second processor, and the second processor generates a target first-type parameter group according to the first data set, the second processor transmits the generated target first-type parameter group to the third processor, and the third processor processes the second data set using the target first-type parameter group to obtain a first-type output, and then transmits the first-type output to the fourth processor.

In one embodiment, the third processor transmits a first-type feedback to the second processor, and the first-type feedback is used to trigger a recalculation or update of the target first-type parameter group.

In one embodiment, the fourth processor transmits a second-type feedback to the first processor, the second-type feedback is used to generate the first data set or the second data set, or the second-type feedback is used to trigger a transmission of the first data set or second data set.

In one embodiment, the first processor generates the first data set and the second data set according to at least a measurement of a radio signal in a measurement of a radio signal, an input of network, time, location, and quality requirements of services, and the first radio signal comprises a first reference signal.

In one subembodiment of the embodiment, the input of the network comprises at least partial parameters comprised in the first signaling.

In one subembodiment of the embodiment, the input of the network comprises the first parameter set.

In one embodiment, the first processor and the third processor belong to a first node.

In one subembodiment of the embodiment, the fourth processor belongs to a second node, and the first-type output comprises second information.

In one subembodiment of the above embodiment, the first node generates the second value.

In one subembodiment of the above embodiment, the first node generates the first location information.

In one subembodiment of the above embodiment, the first node generates the first time information.

In one embodiment, the first-type output comprises second information.

In one embodiment, the second processor belongs to a first node.

The above embodiment avoids passing the first data set to a second node.

In one embodiment, the second processor belongs to a second node.

The above embodiments reduce the complexity of the first node.

In one embodiment, the fourth processor is optional.

In one embodiment, the fourth processor belongs to the first node.

In one subembodiment of the embodiment, the fourth processor is optional.

In one subembodiment of the embodiment, the fourth processor is used to verify the accuracy of the first-type output.

In one embodiment, the first processor and the third processor belong to a second node.

In one subembodiment of the embodiment, the fourth processor belongs to a first node, and the first-type output comprises second information.

In one subembodiment of the embodiment, the fourth processor is optional.

In one subembodiment of the embodiment, the fourth processor is used to verify the accuracy of the first-type output.

In one subembodiment of the embodiment, the first signaling indicates the second information.

In one embodiment, the first signaling comprises at least one of the first location information or the first time information.

In one embodiment, the second node is a transmitter of the first signaling.

In one embodiment, the second node is a serving cell of the first node.

In one embodiment, the first data set is training data, the second data set is Inference Data, the second processor is used to train the model, and the trained model is described by the target first-type parameter group.

In one embodiment, the third processor constructs a model according to the target first-type parameter set, and then inputs the second data set into the constructed model to obtain the first-type output, which is then transmitted to the fourth processor.

In one subembodiment of the above embodiment, the third processor comprises a first encoder in the present application, the first encoder is described by the target first-type parameter group, and a generation of the first class output is executed by the first encoder.

In one embodiment, the third processor calculates the error between the first-type output and the actual data to determine the performance of the trained model; the actual data is data received after the second data set and transmitted by the first processor.

The above embodiment is particularly applicable to prediction-related reporting, such as predicting that the first node is about to enter a location determined by the first location information, how long the first node will remain in the location determined by the first location information, and whether it will exceed the time determined by the first time information.

In one embodiment, the third processor recovers a reference data set according to the first-type output, and the error between the reference data set and the second data set is used to generate the first-type feedback.

In one embodiment, the first-type feedback is used to reflect the performance of the trained model; when the performance of the trained model cannot meet the requirements, the second processing occasion recalculates the target first-type parameter group.

In one subembodiment of the above embodiment, the third processor comprises a first reference decoder in the present application, and the first reference decoder is described by the target first-type parameter group: an input of the first reference decoder comprises the first-type output, and an output of the first reference decoder comprises the reference data set.

Typically, the performance of the trained model is considered unsatisfactory when the error is too large or has not been updated for too long.

In one embodiment of the above embodiment, when the model is used to determine whether the first condition is met, it can be considered that the first condition is not met.

In one embodiment, the third processor belongs to the second node, and the first node reports the target first-type parameter group to the second node.

In one subembodiment of the above embodiment, the second node generates the second value.

In one subembodiment of the above embodiment, the second node generates the first location information.

In one subembodiment of the above embodiment, the second node generates the first time information.

In one embodiment, when the third processor is used to generate first location information and/or the first time information, an input of the third processor may comprise the previously generated first location information and/or first time information.

In one subembodiment of the embodiment, the third processor can iteratively optimize information to be generated.

### Embodiment 8

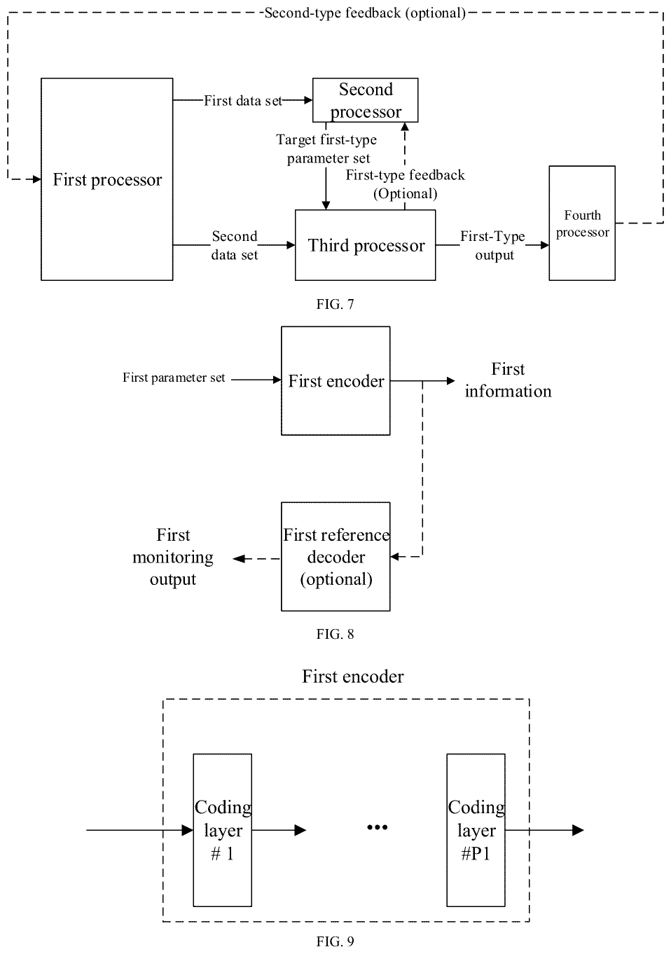

Embodiment 8 illustrates a flowchart of a generation of second information according to one embodiment of the present application, as shown in FIG. 8. In FIG. 8, a first reference decoder is optional.

In one embodiment, in embodiment 8, a first encoder belongs to the first node: herein, the first encoder belongs to a first receiver.

Advantage of the above embodiments is that the capability or information of the first node can be more utilized, especially the information that cannot be shared with the network side, so as to obtain more accurate results. The first node does not need to hand over a large number of parameters or information to the network, saving communication resources and protecting privacy.

In one embodiment, in embodiment 8, a first encoder belongs to the second node; herein, the first encoder belongs to a second receiver.

Advantages of the above embodiment are that the complexity of the first node is reduced and more power is saved, and the network can train and optimize the first encoder using information submitted by multiple users.

In one embodiment, the first receiver generates the second information using a first encoder; herein, an input of the first encoder comprises the first parameter set, and the first encoder is obtained through training.

In one subembodiment of the embodiment, the first parameter set comprises a measurement result for a reference signal or reference signal resources.

In one subembodiment of the embodiment, the network configures the reference signal or reference signal resources.

In one subembodiment of the embodiment, how to configure the reference signal or reference signal resources through signaling in the network is an existing technology in this field.

In one embodiment, the first parameter set comprises a channel parameter matrix, or a matrix composed of at least one eigenvector.

In one embodiment, the first parameter set comprises a first channel matrix.

In one embodiment, the first channel matrix is a precoded matrix used for calculating CQI based on the channel information.

In one embodiment, the first receiver further comprises a first reference decoder, an input of the first reference decoder comprises the second information, and an output of the first reference decoder comprises a first monitoring output.

In one embodiment, the first channel matrix is the first monitoring output.

In one embodiment, the first receiver comprises the third processor in embodiment 7.

In one embodiment, the first parameter set belongs to a second data set in embodiment 7.

In one embodiment, the training of the first encoder is performed at the first node.

In one embodiment, the training of the first encoder is performed by the second node.

In one embodiment, a first-type index is associated with a first encoder.

In one embodiment, a first-type index is an index or identity of a first encoder.

In one embodiment, the first encoder is indexed by the first-type index.

In one embodiment, the first encoder can be indexed by the first-type index.

In one embodiment, the first channel information comprises CSI (channel state information).

In one embodiment, a first channel input comprises a measurement result for downlink reference signal resources.

In one embodiment, the first-type index is associated with a first reference decoder.

In one embodiment, the first-type index is an index or identity of a first reference decoder.

In one embodiment, the first location information depends on the first parameter set.

In one embodiment, the first time information depends on the first parameter set.

In one embodiment, the first reference decoder is indexed by the first-type index.

In one embodiment, the first reference decoder can be indexed by the first-type index.

In one embodiment, the first parameter set comprises a target parameter group.

In one embodiment, the first parameter set comprises geographic location information of the first node.

In one embodiment, the first parameter set comprises geographic location information of the transmitting point.

In one embodiment, the first parameter set comprises map information.

In one embodiment, the first parameter set comprises historical information of the first location information and/or first time information.

In one embodiment, the first parameter set comprises moving speed of the first node.

In one embodiment, the first parameter set comprises an estimate of the moving trajectory of the first node.

In one embodiment, the first parameter set comprises the traffic volume of the first node.

In one embodiment, the first parameter set comprises a delay requirement of services of the first node.

In one embodiment, the first parameter set comprises an estimate of the first location information from other terminals.

### Embodiment 9

Embodiment 9 illustrates a schematic diagram of a first encoder according to one embodiment of the present application, as shown in FIG. 9. In FIG. 9, the first encoder comprises P1 encoding layers, namely encoding layers #1, #2, . . . #P1.

In one embodiment, P1 is 2, that is, the P1 encoding layers comprise encoding layer #1 and encoding layer #2, and the encoding layer #1 and encoding layer #2 are convolutional layer and fully connected layer respectively; in the convolutional layer, at least one convolutional kernel is used to convolve the first parameter set to generate a corresponding feature map, and at least one feature map output by the convolution layer is reshaped into a vector and input to the fully connected layer; the fully connected layer converts the vector into second information. For a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, October 2018 and etc.

In one embodiment, P1 is 3, that is, the P1 coding layers comprise a fully connected layer, a convolutional layer and a pooling layer.

In one embodiment, the first parameter set comprises at least one parameter indicated by the first signaling.

In one embodiment, the second information is generated by the first node.

In one embodiment, the first parameter set comprises at least one parameter reported by the first node.

In one embodiment, the second information is indicated by the first signaling.

In one embodiment, the second information comprises the first location information.

In one embodiment, the second information comprises the first time information.

### Embodiment 10

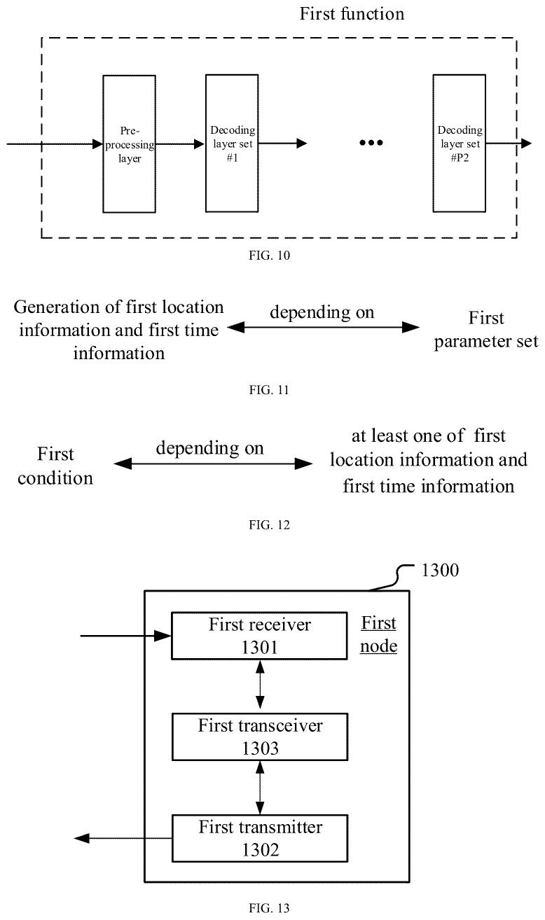

Embodiment 10 illustrates a schematic diagram of a first function according to one embodiment of the present application, as shown in FIG. 10. In FIG. 10, the first function comprises a pre-processing layer and P2 decoding layer groups, namely decoding layer groups #1, #2, . . . , #P2. Each decoding layer group comprises at least one decoding layer.

The structure of the first function is applicable to a first reference decoder in embodiment 8.

In one embodiment, the pre-processing layer is a fully connected layer that enlarges a size of the second information to a size of the first parameter set.

In one embodiment, any two of the P2 decoding layer groups have a same structure, the structure comprises a number of decoding layers, a size of input parameters and a size of output parameters of each comprised decoding layer and etc.

In one embodiment, the second node indicates the structure of the P2 and the decoding layer group to the first node, and the first node indicates other parameters of the first function through the second signaling.

In one embodiment, the other parameters comprise at least one of a threshold of an activation function, a size of the convolution kernel, a step size of the convolution kernel, and the weight between feature maps.

In one embodiment, the first-type index is an input of the first function.

In one embodiment, the first-type index is an output of the first function.

In one embodiment, the first-type index is associated with the first function.

In one embodiment, the first-type index is an index of the first function.

In one embodiment, the first function is indexed by the first-type index.

In one embodiment, the first function can be indexed by the first-type index.

In one embodiment, the first location information may explicitly comprise information about the region.

In one embodiment, the first location information needs to be processed to obtain specific information of the region.

In one subembodiment of the above embodiment, the first location information comprises a sequence.

In one subembodiment of the above embodiment, the first location information comprises an index.

In one subembodiment of the above embodiment, the first location information is information of a compressed region.

In one subembodiment of the embodiment, the first location information is then transmitted to the first node after being processed by embodiment 7 and/or the first encoder.

In one subembodiment of the above embodiment, the phrase of being processed comprises performing decoding by using the first function.

In one embodiment, for any decoding layer group #j, including L layers, i.e. layers #1, #2, . . . , #L; the decoding layer group is any of the P2 decoding layer groups.

In one embodiment, L is 4, the first one layer of the L layers is an input layer, and the last three layers of the L layers are all convolutional layers, and for a more detailed description, refer to CNN-related technical literature, e.g., Chao-Kai Wen, Deep Learning for Massive MIMO CSI Feedback, IEEE WIRELESS COMMUNICATIONS LETTERS, VOL. 7, NO. 5, October 2018 and etc.

In one embodiment, the L layers comprise at least one convolutional layer and a pooling layer.

### Embodiment 11

Embodiment 11 illustrates a schematic diagram of a generation of first location information and first time information depending on a first parameter set according to one embodiment of the present application, as shown in FIG. 11.

In one embodiment, the network indicates the first parameter set.

In one embodiment, the first parameter set is an input parameter of the first-type generator, and the first generator outputs the first location information and the first time information.

In one embodiment, the first parameter set provides generation parameters for generating the first time information from the first location information.

In one subembodiment of the embodiment, the first condition depends on a latter of the first location information and the first time information.

In one subembodiment of the embodiment, the first parameter set comprises a mapping relation.

In one subembodiment of the embodiment, the first parameter set comprises parameters of a generation function for generating the first time information from the first location information.

In one subembodiment of the embodiment, the first parameter set comprises predictions for moving trajectory, and the first time information comprises a time of the arrival at a location determined by the first position information according to the prediction of the moving trajectory.

In one subembodiment of the embodiment, the network uses artificial intelligence and/or past information and/or the current moving speed and/or geographical environment to predict the moving trajectory of the first node.

In one embodiment, the first node generates the first location information and the first time information using the processing method described in Embodiment 7.

In one subembodiment of the embodiment, the first dataset comprises the first parameter set.

In one subembodiment of the embodiment, the first dataset is used for training.

In one subembodiment of the embodiment, the second dataset comprises the first parameter set.

In one subembodiment of the embodiment, the second dataset is used to generate the first location information and the first time information.

In one embodiment, the first signaling indicates the first parameter set.

In one subembodiment of the embodiment, at least one of the first location information or the first time information is generated by the first node.

In one embodiment, the first parameter set comprises a third threshold.

In one embodiment, when a third threshold is a maximum delay allowed by the service of the first node.

In one embodiment, when the third threshold is a maximum delay for retaining an RRC connection of the first node.

In one embodiment, when a third threshold is a DRX (discontinuous reception) cycle of the first node.

In one embodiment, when a third threshold is N times a DRX period of the first node.

In one subembodiment of the above embodiment, N is a positive integer.

In one embodiment, a time determined by the first time information is not longer than the third threshold.

In one embodiment, a location determined by the first location information is not greater than a distance determined by the third threshold and the estimated moving speed of the first node.

In one embodiment, a location determined by the first location information is not greater than a region determined by the third threshold and the estimated motion of the first node.

In one embodiment, a location determined by the first location information is not greater than a region determined by the third threshold and the estimated motion of the first node within a region with the worst radio link quality.

In one embodiment, the first condition comprises being configured with the first RRC information block.

In one embodiment, the first parameter set comprises a first region, and the first location information comprises the first region.

In one subembodiment of the above embodiment, the first node generates the first location information.

In one embodiment, the first parameter set comprises a second region, and the first location information does not comprise the second region.

In one subembodiment of the above embodiment, the first node generates the first location information.

In one embodiment, advantages of the above two embodiments comprise: the first node can be assisted in generating the first location information more accurately.

In one embodiment, the first parameter set comprises a generation model that indexes at least one of first location information and first time information, and/or an encoder and/or an index of the first function.

In one embodiment, the first parameter set comprises a first time interval, and the first time information comprises the first time interval.

In one subembodiment of the above embodiment, the first node generates the first time information.

In one embodiment, the first parameter set comprises a second time interval, and the first time information does not comprise the second time interval.

In one subembodiment of the above embodiment, the first node generates the first time information.

In one embodiment, advantages of the above two embodiments comprise: the first node can be assisted in generating the first time information more accurately:

In one embodiment, the first parameter set indicates a number of iterations used in the model for generating the first location information and/or the first time information.

In one embodiment, the first parameter set indicates a configuration of an encoder that generates the first location information and/or the first time information, such as a number of layers.

In one embodiment, the first parameter set comprises coverage information, such as the covered heat map.

In one embodiment, the first parameter set comprises measurement results of other nodes.

In one embodiment, the first parameter set comprises interference information, such as interference maps.

In one embodiment, the first parameter set comprises an intermediate result, such as an intermediate result of the first encoder.

In one subembodiment of the embodiment, the first node and the network jointly train and/or generate the first location information and/or the first time information.

In one embodiment, the first parameter set indicates at least one reference signal resource.

In one embodiment, the first node generating the first location information and/or the first time information must use a measurement result on at least one reference signal resource indicated by the first parameter set.

In one embodiment, the first parameter set indicates a generation accuracy or confidence level of at least one of the first location information or the first time information.

### Embodiment 12

Embodiment 12 illustrates a schematic diagram of a first condition depending on at least one of first location information or first time information according to one embodiment of the present application, as shown in FIG. 12.

In one embodiment, a location determined by the first location information may be a region.

In one embodiment, the first condition is met when within a region identified by the first location information.

In one embodiment, the first condition is met when within a time period determined by the first time information.

In one embodiment, the first condition is met when within a region determined by the first location information and within a time determined by the first time information.

In one embodiment, the first location information comprises Z-axis information, i.e. height information.

In one embodiment, the first location information depends on the first time information.

In one subembodiment of the embodiment, correspond to different sub information in the first location information at different times indicated by the first time information.

In one subembodiment of the embodiment, the first location information may be different at different times indicated by the first time information.

In one subembodiment of the embodiment, a location or region determined by the first location information depends on being at or expected to be at a time determined by the first time information.

In one subembodiment of the embodiment, the first node first determines whether it is at or expected to be at a time determined by the first time information, and then determines the first location information according to the time determined by the first time information, for example, through a mapping relation.

In one embodiment, a third processor in Embodiment 7 determines whether the first condition is met, and an input of the third processor comprises the first location information and/or the first time information.

In one embodiment, the first encoder in Embodiment 9 determines whether the first condition is met, and an input of the first encoder comprises the first location information and/or the first time information.

In one embodiment, a first-type generator determines whether the first condition is met, and an input of the first-type generator comprises the first location information and/or the first time information.

In one embodiment, the first node is currently in a region determined by the first location information, and the first condition is met.

In one embodiment, the first node is currently within a time determined by the first time information, the first condition is met.

In one embodiment, the first node is currently within a region determined by the first location information and within a time determined by the first time information, and the first condition is met.

In one embodiment, the first node is expected to be in a region determined by the first location information, and the first condition is met.

In one subembodiment of the embodiment, the first node is expected to be within a region determined by the first location information at a moment determined by a first value after the first timer starts.

In one subembodiment of the embodiment, the first node is expected to be within a region determined by the first location information at a moment determined by a second value after the first timer starts.

In one subembodiment of the embodiment, the first node is expected to be within a region determined by the first location information at a moment determined by a greater of the first value and the second value after the first timer starts.

In one embodiment, the first node is expected to be in a time determined by the first time information, and the first condition is met.

In one subembodiment of the embodiment, a moment expected to be determined by a first value after a beginning of the first timer belongs to a time determined by the first time information.

In one subembodiment of the embodiment, a moment expected to be determined by a second value after a beginning of the first timer belongs to a time determined by the first time information.

In one subembodiment of the embodiment, a moment expected to be determined by a greater of the first value and the second value after a beginning of the first timer is fall within a region determined by the first location information.

In one embodiment, the first node is expected to be within a region determined by the first location information and within a time determined by the first time information, and the first condition is met.

In one subembodiment of the embodiment, a moment expected to be determined by a first value after a beginning of the first timer belongs to a time determined by the first time information; the first node is expected to be within a region determined by the first location information at a moment determined by a first value after the first timer starts.

In one subembodiment of the embodiment, a moment expected to be determined by a second value after a beginning of the first timer belongs to a time determined by the first time information; the first node is expected to be within a region determined by the first location information at a moment determined by a second value after the first timer starts.

In one subembodiment of the embodiment, a moment determined by a greater one of the first value and the second value after a beginning of the first timer is expected to fall within a region determined by the first location information; the first node is expected to be within a region determined by the first location information at a moment determined by a second value after the first timer starts.

In one embodiment, candidate values of the first timer comprise the first value and the second value.

In one embodiment, the first value is a default value among the candidate values of the first timer.

In one subembodiment of the above embodiment, the first value is configured by the first signaling.

In one embodiment, if there is a candidate value among candidate values of the first timer for the first node, such that at a moment determined by the candidate value after the first timer starts, the first node is expected to not be in a location determined by the first location information, then the first condition is met: otherwise, the first condition is not met.

In one subembodiment of the embodiment, the candidate values of the first timer comprise or only comprise the first value and the second value.

In one subembodiment of the embodiment, the second value is the candidate value.

In one subembodiment of the embodiment, the first value is a smallest one in candidate values of the first timer.

In one subembodiment of the embodiment, the second value is a smallest one of all candidate values that enable the first node not expected to be in a location determined by the first location information at a moment determined by the candidate value after the start of the first timer.

In one subembodiment of the embodiment, the first node will inevitably enter or pass a location determined by the first location information during a running period of the first timer.

### Embodiment 13

Embodiment 13 illustrates a structure block diagram of a processor in a first node according to one embodiment of the present application, as shown in FIG. 13. In FIG. 13, a processor 1300 in a first node comprises a first receiver 1301, a first transmitter 1302 and a first transceiver. In embodiment 13,
a first receiver 1301 receives a first signaling, and the first signaling configures a first timer; an expiration of the first timer determines that there is a connection problem;
a first transceiver 1303 starts the first timer, and a value of the first timer depends on a first condition; when the first condition is met, a value of the first timer is a first value; when the first condition is not met, a value of the first timer is a second value;
herein, the meaning of the phrase that an expiration of the first timer determines that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

In one embodiment, the first transmitter 1302 transmits first information; the first information indicates a first capability;
herein, the first capability supports using multiple values for the first timer; the first signaling depends on the first capability;

In one embodiment, the first transmitter 1302 transmits first information; the first information indicates a second capability;
herein, the second capability supports a first-type generator: the first-type generator depends on training: the first-type generator determines whether the first condition is met.

In one embodiment, the first receiver 1301 receives a second signaling, the second signaling comprises a first parameter set, and a generation of the first location information and the first time information depends on the first parameter set:
herein, the meaning of the phrase that a generation of the first location information and the first time information depends on the first parameter set comprises: the first parameter set indicates a prediction model that generates at least one of the first location information or the first time information, or the training of the prediction model that generates at least one of the first location information or the first time information depends on the first parameter set.

In one embodiment, the phrase that the first signaling configures a first timer comprises configuring the first value and the second value.

In one embodiment, the phrase that the first signaling configures a first timer comprises configuring the first value and a first increment, and the second value is equal to a sum of the first value and the first increment.

In one embodiment, the phrase that the first signaling configuring a first timer comprises configuring the first value and a first value range, and the second value depends on the first value and the first range.

In one embodiment, a first transceiver 1303 starts a second timer, and a value of the second timer depends on a second condition;
herein, the first signaling configures the second timer, and an expiration of the second timer determines that there is a problem with data reception; the meaning of the phrase that an expiration of the second timer determines that there is a connection problem is: an expiration of the second timer triggers dropping at least one packet, or an expiration of the second timer triggers submitting at least one SDU to a higher layer, or an expiration of the second timer determines losing an uplink synchronization; the second condition depends on at least one of second location information or second time information; when the second condition is met, a value of the second timer is a third value; when the second condition is not met, a value of the second timer is a fourth value.

In one embodiment, problems to be solved by the above embodiments include: how to more accurately determine a value of a timer used to determine data reception problems.

In one embodiment, advantages of the above method comprise: being more flexible, being more accurate, avoiding communication interruption, reducing the time of communication interruption, better adapting to the complex and changeable channel environment, saving more resources, and improving the user experience.

In one embodiment, the second timer does not depend on the first timer, i.e. the above embodiments alone can solve the above technical problems and obtain at least one of the expected benefits.

In one embodiment, the first node is a UE and a mobile.

In one embodiment, the first node is an intelligent terminal or sensor.

In one embodiment, the first node is a terminal that supports large delay differences.

In one embodiment, the first node is an aircraft, vessel, or vehicle terminal.

In one embodiment, the first node is an Internet of Things terminal or an Industrial Internet of Things terminal.

In one embodiment, the first node is a device that supports transmission with low-delay and high-reliability.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly; each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets, vessel communications equipment and other wireless communication devices. The base station or system equipment in the present application includes but is not limited to macro cellular base stations, micro cellular base stations, home base stations, relay base stations, gNB (NR Node B) NR Node B, TRP (Transmitter Receiver Point), NTN base stations, flight platform equipment and other wireless communication devices.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling configuring a first timer; an expiration of the first timer determining that there is a connection problem; and
a first transceiver, starting the first timer, a value of the first timer depending on a first condition; when the first condition is met, a value of the first timer being a first value; when the first condition is not met, a value of the first timer being a second value;
wherein the meaning of an expiration of the first timer determining that there is a connection problem is: an expiration of the first timer triggers entering RRC (Radio Resource Control)_IDLE state, or an expiration of the first timer triggers an RRC connection re-establishment, or RRC reports connection failure to higher layers; the first condition depends on at least one of first location information or first time information.

2. The first node according to claim 1, comprising:
a first transmitter, transmitting first information; the first information indicating a first capability;
wherein the first capability supports using multiple values for the first timer; the first signaling depends on the first capability.

3. The first node according to claim 1, comprising:
a first transmitter, transmitting first information; the first information indicating a second capability;
wherein the second capability supports a first-type generator; the first-type generator depends on training; the first-type generator determines whether the first condition is met.

4. The first node according to claim 2, comprising:
a first transmitter, transmitting first information; the first information indicating a second capability;
wherein the second capability supports a first-type generator; the first-type generator depends on training; the first-type generator determines whether the first condition is met.

5. The first node according to claim 1, comprising:
the first receiver, receiving a second signaling, the second signaling comprising a first parameter set, and a generation of the first location information and the first time information depending on the first parameter set;
wherein the meaning of a generation of the first location information and the first time information depending on the first parameter set comprises: the first parameter set indicates a prediction model that generates at least one of the first location information or the first time information, or the training of the prediction model that generates at least one of the first location information or the first time information depends on the first parameter set.

6. The first node according to claim 2, comprising:
the first receiver, receiving a second signaling, the second signaling comprising a first parameter set, and a generation of the first location information and the first time information depending on the first parameter set;
wherein the meaning of a generation of the first location information and the first time information depending on the first parameter set comprises: the first parameter set indicates a prediction model that generates at least one of the first location information or the first time information, or the training of the prediction model that generates at least one of the first location information or the first time information depends on the first parameter set.

7. The first node according to claim 3, comprising:
the first receiver, receiving a second signaling, the second signaling comprising a first parameter set, and a generation of the first location information and the first time information depending on the first parameter set;
wherein the meaning of a generation of the first location information and the first time information depending on the first parameter set comprises: the first parameter set indicates a prediction model that generates at least one of the first location information or the first time information, or the training of the prediction model that generates at least one of the first location information or the first time information depends on the first parameter set.

8. The first node according to claim 1, wherein
the first signaling configuring a first timer comprises configuring the first value and the second value.

9. The first node according to claim 1, wherein
the first signaling configuring a first timer comprises configuring the first value and the first increment, and the second value is equal to a sum of the first value and the first increment.

10. The first node according to claim 1, wherein
the first signaling configuring a first timer comprises configuring the first value and a first value range, and the second value depends on the first value and the first range.

11. The first node according to claim 2, wherein
the first signaling configuring a first timer comprises configuring the first value and a first value range, and the second value depends on the first value and the first range.

12. The first node according to claim 3, wherein
the first signaling configuring a first timer comprises configuring the first value and a first value range, and the second value depends on the first value and the first range.

13. The first node according to claim 1, comprising:
a first transceiver, starting a second timer, and a value of the second timer depending on a second condition;
wherein the first signaling configures the second timer, and an expiration of the second timer determines that there is a problem with data reception; the meaning of an expiration of the second timer determining that there is a connection problem is: an expiration of the second timer triggers dropping at least one packet, or an expiration of the second timer triggers submitting at least one Service Data Unit (SDU) to a higher layer, or an expiration of the second timer triggers losing an uplink synchronization; the second condition depends on at least one of second location information or second time information; when the second condition is met, a value of the second timer is a third value; when the second condition is not met, a value of the second timer is a fourth value.

14. The first node according to claim 2, comprising:
a first transceiver, starting a second timer, and a value of the second timer depending on a second condition;
wherein the first signaling configures the second timer, and an expiration of the second timer determines that there is a problem with data reception; the meaning of an expiration of the second timer determining that there is a connection problem is: an expiration of the second timer triggers dropping at least one packet, or an expiration of the second timer triggers submitting at least one SDU to a higher layer, or an expiration of the second timer triggers losing an uplink synchronization; the second condition depends on at least one of second location information or second time information; when the second condition is met, a value of the second timer is a third value; when the second condition is not met, a value of the second timer is a fourth value.

15. The first node according to claim 3, comprising:
a first transceiver, starting a second timer, and a value of the second timer depending on a second condition;
wherein the first signaling configures the second timer, and an expiration of the second timer determines that there is a problem with data reception; the meaning of an expiration of the second timer determining that there is a connection problem is: an expiration of the second timer triggers dropping at least one packet, or an expiration of the second timer triggers submitting at least one SDU to a higher layer, or an expiration of the second timer triggers losing an uplink synchronization; the second condition depends on at least one of second location information or second time information; when the second condition is met, a value of the second timer is a third value; when the second condition is not met, a value of the second timer is a fourth value.

16. The first node according to claim 1, wherein
the starting the first timer comprising setting a value of the first timer according to whether the first condition is met.

17. A method in a first node for wireless communications, comprising:
receiving a first signaling, the first signaling configuring a first timer; an expiration of the first timer determining that there is a connection problem; and
starting the first timer, a value of the first timer depending on a first condition; when the first condition is met, a value of the first timer being a first value; when the first condition is not met, a value of the first timer being a second value;
wherein the meaning of an expiration of the first timer determining that there is a connection problem is: an expiration of the first timer triggers entering RRC_IDLE state, or an expiration of the first timer triggers an RRC connection re-establishment, or RRC reports connection failure to higher layers; the first condition depends on at least one of first location information or first time information.

18. The method in a first node according to claim 17, comprising:
transmitting first information; the first information indicating a first capability;
wherein the first capability supports using multiple values for the first timer; the first signaling depends on the first capability.

19. The method in a first node according to claim 18, comprising:
transmitting first information; the first information indicating a second capability;
wherein the second capability supports a first-type generator; the first-type generator depends on training; the first-type generator determines whether the first condition is met.

20. The method in a first node according to claim 19, comprising:
receiving a second signaling, the second signaling comprising a first parameter set, and a generation of the first location information and the first time information depending on the first parameter set;
wherein the meaning of a generation of the first location information and the first time information depending on the first parameter set comprises: the first parameter set indicates a prediction model that generates at least one of the first location information or the first time information, or the training of the prediction model that generates at least one of the first location information or the first time information depends on the first parameter set.
